(19) United States
(12) Patent Application Publication
(10) Pub. No.: US 2003/0173822 A1
(43) Pub. Date: Sep. 18, 2003

(54) Method for manufacturing a wheel and a wheel obtained thereby

(76) Inventors: Flavio Frigo, Ponzano Veneto (IT); Michele Pozzobon, Fossalonga Di Vedelago (IT)

Correspondence Address: Modiano & Associati, Via Meravigli 16, Milano, 20123, IT

(21) Appl. No.: 10/312,759

(22) PCT Filed: May 23, 2002
(86) PCT No.: PCT/EP02/05670

(30) Foreign Application Priority Data
May 24, 2001 (IT) TV2001A000066

(51) Int. Cl. B60B 3/10

(52) U.S. Cl. 301/63.101

(57) ABSTRACT

A method for manufacturing a wheel and the wheel obtained thereby, particularly for use in skates and/or rollers. The method comprise the steps of obtaining a rim (1) by way of an extrusion process, machining said rim for defining at least an outer rim (13), and coupling a tread (12) to the rim, in order to form a wheel.

### TECHNICAL FIELD

The present invention relates to a method for manufacturing a wheel and to a wheel obtained thereby, such wheel being particularly suitable for use in skates, rollers and the like, particularly in-line skates.

### BACKGROUND ART

It is known that a skate or a roller typically comprises a sports shoe, which is associated to a frame. The frame is operatively connected to one or more wheels that are free to roll on a rolling plane.

Known wheels, adopted for skating/rolling purposes, comprise a rim that includes a central hub and a co-axial outer rim, the outer edge of which is suitable for interconnection with a tread, for example made of plastics, such as polyurethane. In a conventional wheel, the central hub is integrally connected to a coaxial outer rim. For this aim, manufacturing processes, involving a single moulding operation of plastic material, are usually adopted. Alternatively, processes, involving one or more injections of plastic material into a mould, are also known.

U.S. Pat. No. 5,312,844 discloses a method for manufacturing the rim of a skate wheel by means of an injection process. Basically, this method comprises the following steps:

a first step, in which a polymeric material is put into an injection device that is designed to inject a plastic material (e.g. molten polyurethane);

a second step, in which the injection device is heated until the polymeric material is molten;

a third step, in which a hub is positioned in a mould, which has been previously heated;

a fourth step, in which the polymeric material is injected under pressure into the mould;

a fifth step, in which the mould is cooled until solidification of the polymeric material is completed.

In order to obtain a finished wheel a tread is coupled to the rim. For this aim, over-injection or gluing processes are adopted.

An important drawback of such known manufacturing methods is related to their relatively low level of flexibility; for example, usually, it is necessary to make a new mould, whenever variations to the shape or to the size of the rim are desired. Given the fact that such modifications/variations of the wheel are. often required by the market, this relatively poor manufacturing flexibility implies that such known manufacturing methods are often relatively expensive and time consuming.

Additionally, the practice has shown that such known manufacturing methods often provide rims with non-homogeneous mechanical characteristics and unsatisfactory finish. Therefore, additional and relatively time consuming finishing/grinding steps are frequently required.

### DISCLOSURE OF THE INVENTION

Thus, the main object of the present invention is to provide a method for manufacturing a wheel and the wheel obtained thereby, such wheel being particularly suitable for use in skates, rollers and the like and allowing to overcome the described technical problems, mentioned above.

Within this aim, an object of the present invention is to provide a method for manufacturing a wheel which is simple to carry out and to modify according to the needs.

Another object of the present invention is to provide a method for manufacturing a wheel which is particularly flexible and allows performing variations/modifications of the manufactured wheel in a relatively quick and inexpensive manner.

Another object of the present invention is to provide a method for manufacturing a wheel which allows to obtain rims that are provided with highly homogeneous mechanical characteristics as well as an excellent surface finishing.

Therefore, the present invention provides a method for manufacturing a wheel and the wheel obtained thereby, such wheel being particularly suitable for use in skates and/or rollers, characterised in that it comprises the steps of:

obtaining a rim by means an extrusion process, the rim comprising at least an axial through hole and a plurality of stress-relief regions extending substantially radially from the through hole;

machining the rim, so as to define at least an outer rim, the outer rim being provided with at least a substantially circular outer edge; and

coupling a coaxial tread externally to the outer rim, so as to form a wheel the coupling being performed substantially at the outer edge of the outer rim.

### BRIEF DESCRIPTION OF THE DRAWINGS

Further characteristics and advantages of the invention will become better apparent from the detailed description of some embodiments of the method according to the present invention, illustrated by way of non-limitative example, in the accompanying drawings, wherein:

FIGS. 1 and 2 are schematic views respectively of a semi-finished rim obtained by means of an embodiment of the method, according to the present invention;

FIGS. 3 and 4 are schematic views respectively of a semi-finished rim-structure obtained by means of a second embodiment of the method, according to the present invention;

FIG. 5 is a schematic view of a rim obtained by means of a third embodiment of the method, according to the present invention;

FIGS. 6 and 7 are different schematic views of the rim illustrated in FIG. 5; and

FIGS. 8 and 9 are schematic views of a wheel obtained by means of still another embodiment of the method, according to the present invention.

### WAYS OF CARRYING OUT THE INVENTION

As mentioned above, the method, according to the present invention, is particularly suitable for manufacturing a wheel 14, particularly for use in skates and/or rollers.

The method, according to the present invention, comprises a step of obtaining a semi-finished rim 1 by means of an extrusion process. The rim 1 is preferably made of metal, such as aluminium or a light alloy; of course, it is possible to use also other known materials (e.g. non-metallic materials) that are compatible with an extrusion process.

With reference to the figures, the rim 1 is preferably provided with an axial through hole 4 and a plurality of stress-relief regions 5 that extend substantially in a radial fashion from the through hole 4. The present method provides also a step in which the semi-finished rim 1 is machined, so as to define an outer rim 3, which is provided with at least a substantially circular outer edge 10. According to a preferred embodiment of the present method an additional step can also be adopted, in which the semi-finished rim 1 is machined, so as to define a central hub 2, which is substantially co-axial to the through hole 4 and which is provided with a first end 2a and a second end 2b. Finally, the present method provides for coupling a coaxial tread 12 externally to the outer rim 3 (FIGS. 8-9) of the rim 1. The coupling is performed substantially at the outer edge 10, so as to form a wheel 14. Preferably, the coaxial tread 12 is made of resilient plastic material. For coupling purposes, an over-injection or gluing processes can be advantageously used.

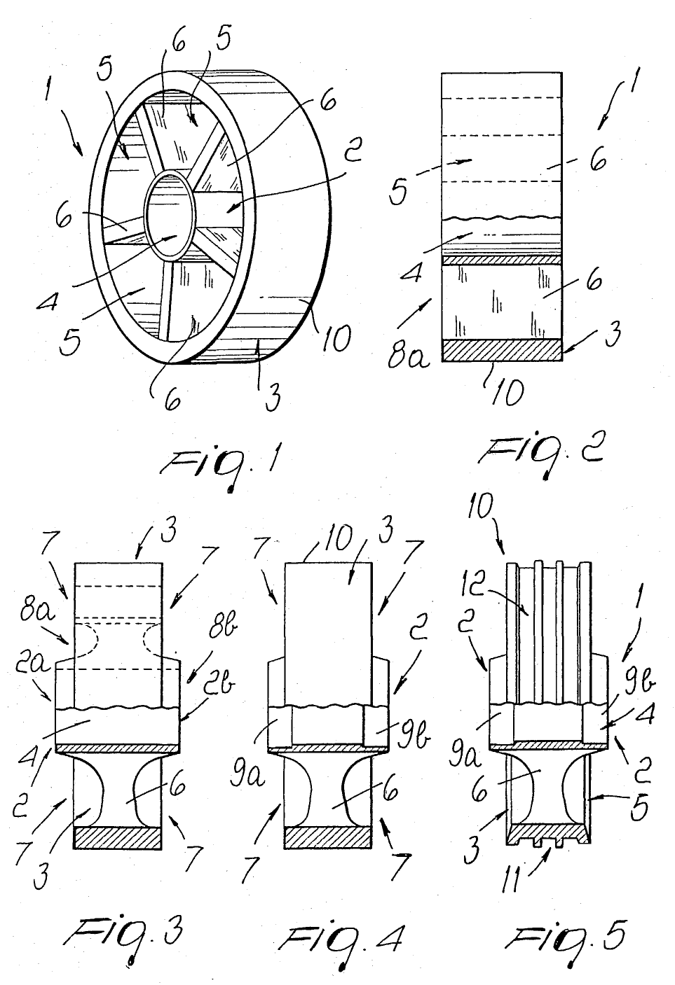

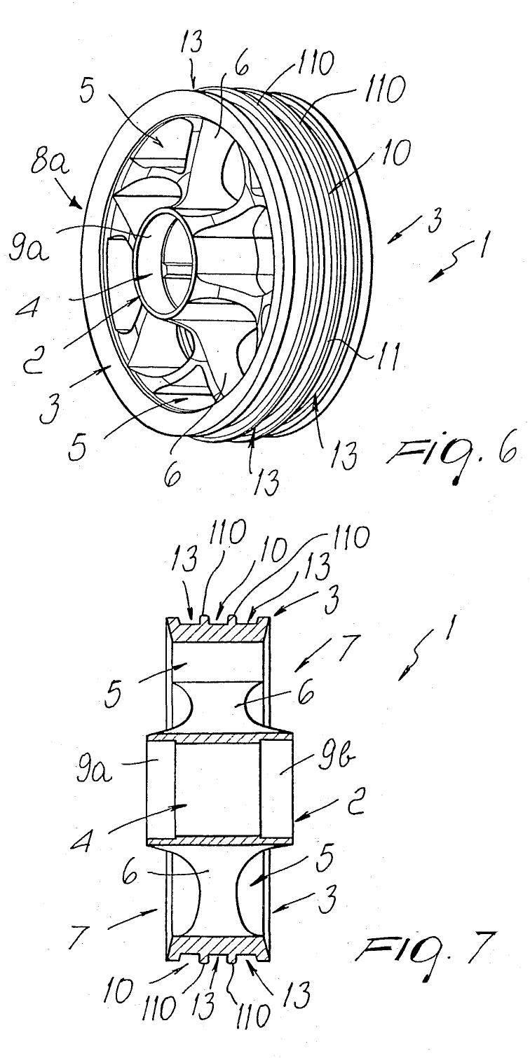

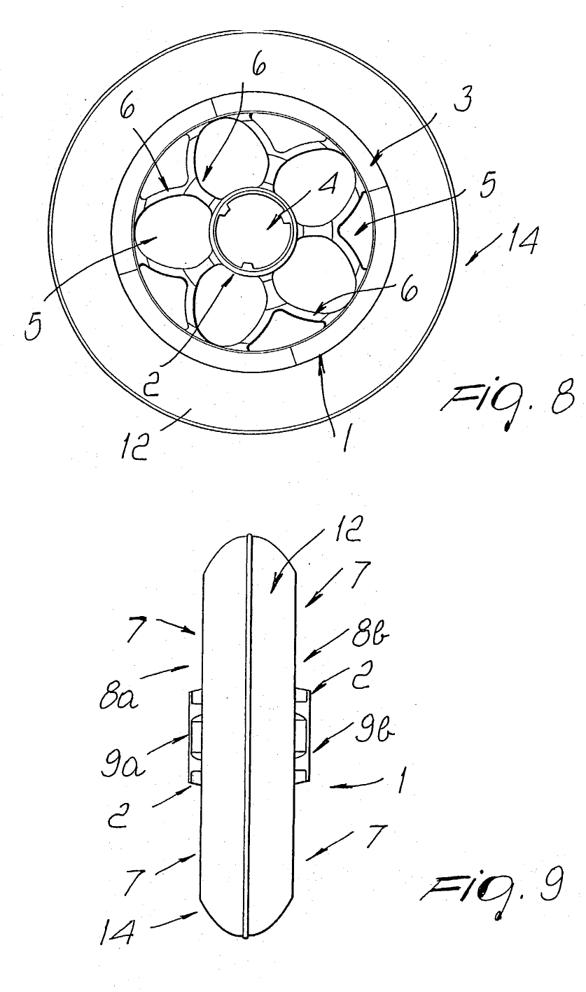

Preferably, the present method comprises also the step of machining the semi-finished rim 1, so as to obtain, at the stress-relief areas 5, one or more radial elements 6 (FIGS. 1, 6 and 8), which connect the central hub 2 to the outer rim 3. Preferably, a plurality of radial elements 6, which are suitably equally spaced apart, can be provided. Advantageously, during this step, a partial reduction can be also obtained of the thickness of the semi-finished rim 1 (FIGS. 3, 5, 7 and 9); such reduction in thickness, or tapering, is preferably accomplished in the outer regions 7 on both faces 8a and 8b of the semi-finished rim 1 (FIG. 3). Advantageously, tapering does not involve the central hub 2, which can be obtained with a predefined axial length. In this manner (FIGS. 3-9), the width of the radial elements 6 and/or the outer rim 3, along a first direction that is substantially co-axial to the through hole 4, is smaller than the axial length of the central hub 2, along the same first direction. This allows obtaining an overall reduction in weight while maintaining substantially unchanged the overall stiffness of the rim 1.

In a preferred embodiment, the present method provides also a step, in which the semi-finished rim 1 is machined, so as to reduce the internal thickness of the central hub 2. This allows defining one or more cylindrical seats 9a and 9b, respectively positioned at the first end 2a and/or at the second end 2b of the central hub 2 (FIGS. 4-5, 7 and 9). Two conventional bearings, not illustrated, may be positioned in these cylindrical seats 9a and 9b. Thus, such bearings can operatively interact with a central pin (not illustrated), which supports, for example, an upper skate frame (not illustrated). In this manner, the rotation of the central hub 2 in relation to the mentioned central pin is allowed and, therefore, the free rotation of the wheel 14 is possible.

In another advantageous embodiment of the present method a step is provided, in which the semi-finished rim 1 is machined, so as to obtain, at the outer edge 10, first means 11 for improving the adherence of the tread 12 to the outer rim 3 (FIGS. 5-7). The first means 11 are advantageously obtained by removal of material and may comprise, for example, one or more parallel, circular grooves 13, defined between one or more pairs of circular ribs 110. Alternatively, the first means 11 may comprise a plurality of projections, not illustrated in the figures, projecting radially from the outer edge 10, so as to allow a better adherence of the tread 12 to the outer edge 10.

Finally, the method, according to the present invention, may comprise a step of machining the semi-finished rim 1 by way of a relatively simple surface treatment, such as sanding. This allows to remarkably improve the surface finish of the semi-finished rim 1.

It has thus been shown that the method, according to the present invention, allows to achieve the intended aims and objects. Even if the adoption of an extrusion process step for manufacturing the rim may appear an expensive choice at a first analysis, the practice has proven that it allows reducing the overall costs of production of wheels, with respect to the known manufacturing methods. This is due to the fact that, thanks to the adoption of an extrusion process step, the rims can be manufactured in a very quick and flexible manner. In this way, variations/modifications of the wheel (which are always required by the market) can be planned/executed without delays and, most of all, without increasing the production costs.

Further, the adoption of an extrusion process step for manufacturing the rim allows adopting relatively simple machining steps, involving removal of material, which allow improving the overall mechanical features of the wheel. Thus, thanks to the adoption of an extrusion process, the method, according to the present invention, allows obtaining rims that enjoy highly homogeneous mechanical characteristics as well as an excellent surface finish.

The disclosures in Italian Patent Application No. TV2001A000066 from which this application claims priority are incorporated herein by reference.

1. A method for manufacturing a wheel, particularly for use in skates and/or rollers, characterised in that it comprises the steps of:
obtaining a rim by means of an extrusion process, said rim being provided with an axial through hole and a plurality of stress-relief regions extending substantially radially from said through hole;
machining said rim so as to define at least an outer rim, which is provided with at least a substantially circular outer edge; and
coupling a tread to said outer rim, said tread being positioned substantially coaxially and externally to said outer rim and being coupled to said outer rim substantially at said outer edge.

2. The method according to claim 1, characterised in that it comprises the additional step of:
machining said rim so as to define a central hub, which is substantially co-axial to said through hole and which is provided with a first end and a second end.

3. The method according to claim 2, characterised in that it comprises the additional step of:
machining said rim, so as to reduce the internal thickness of said central hub and define one or more cylindrical seats positioned at said first end and/or at said second end.

4. The method according to one or more of the preceding claims, characterised in that it comprises the additional step of:
machining said rim so as to obtain, at said circular outer edge, first means for improving the adherence of said tread to said outer rim.

5. The method according to claim 4, characterised in that said first means comprise one or more parallel circular grooves, defined between one or more pairs of circular ribs.

6. The method according to claim 4, characterised in that said first means comprise one or more overhangs projecting radially from said outer rim.

7. The method according to one or more of the preceding claims, characterised in that it comprises the additional step of:
machining said rim, so as to obtain, at said stress-relief regions, at least a radial element connecting said central hub and said outer rim.

8. The method according to one or more of the preceding claims, characterised in that the width of said radial element and/or of said outer rim, along a first direction that is substantially co-axial to said through hole, is smaller than the axial length of said central hub along said first direction.

9. The method according to one or more of the preceding claims, characterised in that it comprises the additional step of:
machining said rim by means of a surface treatment.

10. The method according to one or more of the preceding claims, characterised in that said rim is made of metal or of a light alloy.

11. A wheel particularly for use in skates or rollers, characterised in that it is manufactured by means of a method, according to one or more of the preceding claims.

12. A wheel particularly for use in skates or rollers or the like, comprising: a rim which is provided with an axial through hole, a plurality of stress-relief regions extending substantially radially from said through hole and an outer rim, which is provided with at least a substantially circular outer edge; and a tread, which is positioned substantially co-axially and externally to said outer rim and which is coupled to said outer rim substantially at said outer edge characterised in that said rim is obtained, at least partially, by way of an extrusion process.

13. A gliding device, such as a skate or a roller and the like, comprising a sports shoe for accomodating the foot of a user, a frame associated to said sports shoe, and one or more wheels associated to said frame, characterised in that it comprises at least a wheel according to claims 11 or 12.
